(19) United States
(12) Patent Application Publication
(10) Pub. No.: US 2006/0062893 A1
(43) Pub. Date: Mar. 23, 2006

(54) Method for producing meat extract

(76) Inventors: Motokazu Nakayama, Tochigi (JP); Akihito Fujimoto, Ibaraki (JP); Makoto Watanabe, Yamaguchi (JP); Takahisa Miyamoto, Fukuoka (JP)

Correspondence Address: DARBY & DARBY P.C., P. O. BOX 5257, NEW YORK, NY, 10150-5257, US

(21) Appl. No.: 10/540,655

(22) PCT Filed: Dec. 25, 2003
(86) PCT No.: PCT/JP03/16698

§ 371 Date: Jun. 23, 2005

(30) Foreign Application Priority Data
Dec. 27, 2002 (JP) 2002378828

(51) Int. Cl. A23L 1/28

(52) U.S. Cl. 426/655

(57) ABSTRACT

The present invention relates to a method for improving the preservation of a meat extract, which comprises a step for adding an emulsifier and a step for UHT sterilization, and also relates to a process for producing a meat extract, which comprises a step for adding an emulsifier and a step for UHT sterilization. The present invention also relates to a meat extract that is obtained by the process for producing thereof.

### BACKGROUND OF THE INVENTION

The present invention relates to a meat extract, a process for producing a meat extract and a method for improving the preservation of a meat extract.

For improving the preservation of food and drink in the distribution thereof, heat sterilization such as retort sterilization is performed. However, heat sterilization sometimes causes deterioration of the quality of food and drink such as generation of cooked odor, loss of flavor by vaporization. To solve this problem, food and drink are distributed in a frozen state (cold chain distribution) but cold chain distribution is costly. Also, insufficient heating in the production of food and drink may cause contamination by bacteria during the distribution.

So-called high-temperature instant sterilization methods such as UHT (Ultra High Temperature) sterilization are able to sterilize liquid type food and drink so that the food and drink may be distributed at normal temperature while minimizing bad effects of heating.

However, when the weakly acidic or neutral liquid foods are subjected to UHT sterilization, heat resistant microorganisms that are generally called spore-forming bacteria may survive. Examples of such microorganisms belong to the genus Bacillus, Sporolactobacillus, Clostridium, or Sporosarcina.

In general, the known method for preventing the deterioration of food and drink by heat resistant spore-forming bacteria through heat treatment are to add sugar ester (Japanese Published Unexamined Patent Application No. 18578/81), monoglycerin fatty acid ester (Japanese Published Unexamined Patent Application No. 61630/76), diglycerin fatty acid ester (Japanese Published Unexamined Patent Application No. 39354/95), polyglycerin fatty acid ester (Japanese Published Unexamined Patent Application No. 163678/87) and the like. However, these methods require heat sterilization at 121° C. for about 30 minutes.

Known methods that do not require heat sterilization at high temperature include sterilization at 50° C. under pressure with the addition of sucrose fatty acid ester (Japanese Published Unexamined Patent Application No. 284949/93), sterilization by adding lysozyme and sucrose fatty acid ester (Japanese Published Unexamined Patent Application No. 2002-234808) and the like.

However, a pressure cooker is required for sterilization under pressured condition which is costly. Since lysozyme is not so effective against gram-negative bacteria, the sterilization using lysozyme may be insufficient.

A meat extract is generally used as a soup. Long term storage of the meat extract requires sterilization such as retort sterilization, but there is a problem of generation of cooked odor by the retort sterilization. Further, the spores of the spore-forming bacteria may survive the UHT sterilization, and therefore the time or temperature for the treatment needs to be increased, causing more cooked odor to be generated.

The sterilization under pressure as the method to avoid heating at high temperature may denature gelatin, which is the main component of the meat extract. Furthermore, sterilization using lysozyme is not suitable for the meat extract, because it may be contaminated with gram-positive as well as gram-negative bacteria.

Because of the reasons described above, an efficient sterilization process that does not affect the quality of the meat extract is required

### DISCLOSURE OF THE INVENTION

The object of the present invention is to provide a method for improving the preservation of a meat extract, a process for producing a meat extract with improved preservation, and a meat extract with improved preservation.

The present invention relates to (1) to (7) below.

(1) A process for producing a meat extract, which comprises a step for adding an emulsifier and a step for sterilizing by a UHT method.

(2) The process according to the above (1), wherein the emulsifier is selected from a group consisting of monoglycerin fatty acid ester, diglycerin fatty acid ester, sucrose fatty acid ester and sorbitan fatty acid ester.

(3) The process according to the above (1) or (2), wherein the meat extract is a clear meat extract.

(4) A method for improving the preservation of the meat extract, which comprises adding an emulsifier and sterilizing by a UHT method.

(5) The method according to the above (4), wherein the emulsifier is selected from a group consisting of monoglycerin fatty acid ester, diglycerin fatty acid ester, sucrose fatty acid ester and sorbitan fatty acid ester.

(6) The method according to the above (4) or (5), wherein the meat extract is a clear meat extract.

(7) A meat extract obtainable by any one of the process according to (1) to (3).

The emulsifier to be used in the present invention may be any of the emulsifier that can be used for food and drink.

For example, glycerin, propylene glycol, sorbitan, sucrose, a fatty acid ester of these or lecithin may be used, but preferably glycerin fatty acid ester, sorbitan fatty acid ester or sucrose fatty acid ester is used.

Glycerin of glycerin fatty acid ester includes monoglycerin, polyglycerin and the like. Polyglycerin may be any of the polyglycerin but preferably diglycerin may be used.

Glycerin fatty acid ester may be any one of mono-, di-, tri-, tetra-, or penta-fatty acid ester of glycerin or polyglycerin, but preferably mono-fatty acid ester. The fatty acids of di-, tri-, tetra-, or penta-fatty acid ester may be the same or different. Fatty acid of glycerin fatty acid ester may be any fatty acid, but saturated or unsaturated fatty acid fatty acid having 8 or more carbon atoms, preferably having 8 or more but not more than 18 carbon atoms, more preferably having 8 or more but not more than 14 carbon atoms may be used. For example, caprylic acid (having 8 carbon atoms), capric acid (having 10 carbon atoms), lauric acid (having 12 carbon atoms), myristic acid (having 14 carbon atoms), palmitic acid (having 16 carbon atoms), stearic acid (having 18 carbon atoms), oleic acid (having 18 carbon atoms) and the like may be used. The fatty acid ester may be used singly or as a mixture of the two or more.

Sorbitan of sorbitan fatty acid ester may be selected from 1, 5-sorbitan, 3, 6-sorbitan and 1, 4-sorbitan. Fatty acid of sorbitan fatty acid ester may be any fatty acid, but saturated or unsaturated fatty acid having 8 or more carbon atoms, preferably having 8 or more but not more than 18 carbon atoms may be used. For example, caprylic acid (having 8 carbon atoms), lauric acid (having 12 carbon atoms), palmitic acid (having 16 carbon atoms), stearic acid (having 18 carbon atoms), oleic acid (having 18 carbon atoms) and the like may be used. The sorbitan fatty acid ester may be used singly or as a mixture of the two or more.

Fatty acid of sucrose fatty acid ester may be palmitic acid (having 16 carbon atoms), stearic acid (having 18 carbon atoms) and the like.

Sucrose fatty acid ester may be a monoester or diester, or mixture of both. In case of a mixture, the content of monoester is preferably 60 percent by weight or more of the mixture or more preferably 70 percent by weight or more.

In the present invention, the meat extract may be produced by extracting from bone or meat of animals with aqueous medium such as water or organic solvent such as alcohol, or a commercial meat extract may be used.

The animal can be any animal, but chicken, cattle or pig may be used preferably. The part of the animal used for the material for extraction may be either bone or meat, and they may be used singly or as a mixture of two or more.

The extraction from the material may be carried out using an extraction medium such as an aqueous medium or an organic solvent, and preferably an aqueous medium is used. As the aqueous medium, water or inorganic salt aqueous solutions is used. The inorganic salts include sodium chloride, potassium chloride, calcium chloride and the like.

Ethanol is used preferably as an organic solvent because it is used for food and drink. Ethanol may be aqueous ethanol, and preferably the aqueous ethanol with water content 10% (v/v) to 90% (v/v) is used.

The extraction may be performed by any apparatus that allows extraction of protein, peptides, and other flavor components from the material. For example, heating apparatus such as an atmospheric cooker or a pressure cooker may be used.

Normally the extraction is performed by adding an extraction medium to the aforementioned material and heating at 60 to 150° C. for 30 minutes to 1 week.

The extraction is also performed by enzyme treatment, by maintaining at room temperature for a long period of time and the like (Japanese Published Unexamined Patent Application No. 130048/91, Japanese Published Unexamined Patent Application No. 259063/91, Japanese Published Unexamined Patent Application No. 062792/94).

After the extraction step, the extract may be subjected to a solid-liquid separation method such as sedimentation separation, cake filtration, clarifying filtration, centrifugal filtration, centrifugal precipitation, compression, separation, or filter press, preferably filtration, to obtain the liquid extract, which may be used as the meat extract.

Furthermore, the oil component generated in the extraction step may be separated and removed at the solid-liquid separation step by using a three-layer separator and the like. The liquid extract without the oil component is transparent and may be used as a clear meat extract.

The clear meat extract in the present invention is defined as the one containing 2% (w/w) or less of crude fat, preferably 1% (w/w) or less. The content of crude fat in the meat extract may be analyzed by the conventional method.

These clear meat extracts are generally used as “Chintan” (clear soup).

The liquid extract, obtained after the solid-liquid separation step, may be concentrated by concentration methods such as heat concentration, reverse osmosis concentration, in vacuo concentration or freeze drying. The concentrated liquid obtained may be used as a meat extract. The meat extracts with high gelatin content are preferably kept above the temperature at which gelatin is solidified, for example, 40° C. or above.

In the production steps of the meat extract described above, the liquid extract from which oil is not removed may be used as it is or the extract, from which oil is removed, may be mixed with the removed oil again, or if necessary, with an oil such as vegetable oil, to prepare meat extract by emulsifying using a homo mixer, a colloid mill, a high pressure homogenizer, a votator, an ultrasonicator and the like. The meat extract obtained by emulsification is generally used as “Paitan” (white soup).

The meat extracts obtained as described above may contain, if necessary, various additives that may be used for food and drink, such as inorganic salts, acids, amino acids, nucleic acids, sugars, or seasonings.

The inorganic salts include sodium chloride, potassium chloride, ammonium chloride and the like. The acids include ascorbic acid, fumaric acid, malic acid, tartaric acid, citric acid, carbonic acid such as fatty acid or the salts thereof. The salts include sodium salts and potassium salts. Amino acids include sodium glutamate, glycine and the like. Nucleic acids include sodium inosinate, sodium guanylate and the like. Sugars include sucrose, glucose, lactose and the like. Seasonings include natural seasonings such as soy sauce, miso (bean paste), extracts and the like, and spices include various spices. The contents of these additives may be set appropriately according to the usage of the meat extract; for example to 100 parts by weight of the meat extract, 0.1 to 500 parts by weight of the additives may be contained.

The meat extract used in the present invention may be any of the meat extracts described above but preferably a clear meat extract.

The emulsifier may be added in any step for producing the meat extract as long as it is before the UHT sterilization step, or may be added after the production of the meat extract and immediately before the UHT sterilization step. It is preferable to add immediately before the UHT sterilization for better control of the concentration of emulsifier. It is preferable that the emulsifier is dissolved in water and the like beforehand and then added.

The amount of the emulsifier to be added is varied depending on the kind of the emulsifier, the species of microorganisms present in the meat extract, the number of microorganisms in the meat extract and the like; the emulsifier is added so that the concentration after the addition is 0.01 percent by weight or more, preferably 0.03 percent by weight or more, more preferably 0.05 percent by weight or more, and even more preferably 0.1 percent by weight or more. There is no particular upper limit of the emulsifier to be added, but it is preferably 5 percent by weight or less.

It is preferable to mix the meat extract and the emulsifier sufficiently after the addition of the emulsifier.

The UHT sterilization in the present invention may be performed by either the direct heating method or the indirect heating method as long as the method can provide the UHT sterilization. The direct heating methods include the steam injection method by which high pressure steam is directly injected into the meat extract, the steam infusion method by which the meat extract is injected into high pressure steam or the Joule heating method by which electric current is applied to the meat extract. Examples of indirect heating methods include a plate heat exchanger method, a tube heat exchanger method and a scraped-surface heat exchanger method.

Any apparatus may be used for the UHT sterilization as long as the apparatus is capable of the UHT sterilization described above. For example, “Asepliser” SDI type (for sterilization by direct heating with steam, Izumi Food Machinery Co.), Joule Heating Sterilization System FJL series (for Joule heating method, Frontier Engineering Co.), “Asepliser” PHX type (for plate-type indirect heating sterilization, Izumi Food Machinery Co.), “Asepliser” SHE type (for scraped-surface indirect heating sterilization Izumi Food Machinery Co.), “Asepliser” THX type (for tube-type indirect heating sterilization, Izumi Food Machinery Co.), Small Volume Liquid Continuous Sterilization Test Machine RMS type (Hisaka Works Co. Ltd.) and the like may be used.

In the present invention, the conditions for UHT sterilization may be chosen appropriately depending on the kind of the emulsifier, the type of the meat extract, the species and the number of microorganisms in the meat extract and the like. Normally the sterilization is carried out at temperature of 120 to 150° C., preferably at 120 to 140° C. The sterilization time is normally for 1 to 60 seconds, preferably for 5 to 30 seconds. Preferably the conditions of the UHT sterilization in the present invention are as follows: if the pH of the meat extract is less than 4.0, it is preferable that the sterilization efficiency is the same or better than that of the heat treatment which is carried out at 65° C. for 10 minutes; and if the pH of the meat extract is 4.0 or above, it is preferable that the sterilization efficiency is the same or better than that of the heat treatment which is carried out at 85° C. for 30 minutes.

The efficiency of sterilization can be determined using the number of colonies as an indicator as described below; and the fewer the colony count, the sterilization is judged to be more efficient. The meat extract is spread on a nutrient agar medium (Nissui Pharmaceutical Co., containing 35 g of meat extract, 10 g of peptone, 15 g of sodium chloride and 15 g of agar in 1 l water); if necessary, the meat extract may be diluted with sterilized water and the like. The agar culture is incubated at 50° C. for 48 hours and the number of colonies developed is counted.

The meat extract that has been sterilized is packed into a sterilized container aseptically.

The embodiments of the present invention are described below.

### BEST MODE FOR CARRYING OUT THE INVENTION

### EXAMPLE 1

a) A sucrose fatty acid ester, DK ester F-160 (monoester content about 70 percent by weight, DAI-ICHI KOGYO SEIYAKU Co. Ltd), was added to the chicken extract prepared in the reference example 1 described below to the final concentrations of 0.1 percent by weight, 0.05 percent by weight, 0.03 percent by weight and 0.01 percent by weight, and the spore suspension of Bacillus stearothermophilus prepared in the reference example 2 was added to the chicken extract so that the final concentration was about 300 spores/ml.

Here, Bacillus stearothermophilus is a type of spore-forming bacteria, and one of the heat resistant bacteria that has a high probability of surviving the normal heat treatment.

Each chicken extract sample was sterilized by the UHT method at 125° C. for 10 seconds using a Small Volume Liquid Continuous Sterilization Test Machine RMS type (Hisaka Works Co. Ltd.), and then packed aseptically into a 300 ml aluminum pouch to prepare the test group 1.

Similarly the test group 2 was prepared in a 300 ml aluminum pouch in the similar manner as the test group 1 except a diglycerin fatty acid ester, Sunsoft Q-14D (having 14 carbon atoms in fatty acid, Taiyo Kagaku Co., Ltd.) was used in place of DK ester F-160 (Dai-Ichi Kogyo Seiyaku Co. Ltd).

The test group 3 was prepared by adding spores of Bacillus stearothermophilus prepared in the reference example 2 to the chicken extract prepared in the reference example 1 to about 300 spores/ml, and then packing the chicken extract into the retort pouch.

Spores of Bacillus stearothermophilus prepared in the reference example 2 was added to the chicken extract prepared in the reference example 1 to about 300 spores/ml, and then the chicken extract was packed into a retort pouch and subjected to retort sterilization at 121° C. for 30 minutes using a Small Volume Liquid Continuous Sterilization Test Machine RMS type (Hisaka Works Co. Ltd.) to prepare the test group 4.

Spores of Bacillus stearothermophilus prepared in the reference example 2 was added to the chicken extract prepared in the reference example 1 to about 300 spores/ml, and then the chicken extract was sterilized by the UHT method at 135° C. for 10 seconds using a Small Volume Liquid Continuous Sterilization Test Machine RMS type (Hisaka Works Co. Ltd.), and then packed aseptically into a 300 ml aluminum pouch to prepare the test group 5.

In the test group 6, the chicken extract was packed aseptically into a 300 ml aluminum pouch in the same manner as in the test group 5 except that the heating treatment was carried out at 125° C.

Each test group is summarized in Table 1.

TABLE 1

| | | | Sterilization | |
|---|---|---|---|---|
| | | Sterilization | Temperature | Sterilization |
| Test Group | Emulsifier | Method | (° C.) | Time |
| 1 | Sucrose fatty | UHT | 125 | 10 seconds |
| | acid ester | | | |
| 2 | Diglycerin fatty | UHT | 125 | 10 seconds |
| | acid ester | | | |
| 3 | None | No | No | No |
| | | sterilization | sterilization | sterilization |
| 4 | None | Retort | 121 | 30 minutes |
| 5 | None | UHT | 135 | 10 seconds |
| 6 | None | UHT | 125 | 10 seconds |

A panel of 6 experts performed sensory tests on the chicken extract of test groups 3 to 6. Cooked odor and palatability were evaluated in the tests.

As the result, it was evaluated that the cooked odor was strong in the following order; test group 4>test group 5>test group 3 and test group 6.

That is, the chicken extract of the test group 4, which had been treated by the retort sterilization had a stronger cooked odor than that of the test group 3, which was not treated with heat. The chicken extract of the test groups 5 and 6, which had been treated by the UHT sterilization, obviously had a weaker cooked odor than that of the test group 4. Furthermore, the cooked odor of the chicken extract of the test group 6 was equal to that of the chicken-extract of test group 3 which was not treated with heat and weaker than that of the chicken extract of test group 5.

The palatability of the chicken extracts was evaluated from not-so-favorable to favorable which is indicated in that order; test group 4>test group 5>test group 6>test group 3.

That is, the most favorable palatability was found in the test group 3, which had not been heat treated and the most unfavorable palatability was found in the test group 4, which had been treated with retort sterilization. Among the test groups that were treated by the UHT sterilization, the test group 6, which was treated at lower temperature, was more favorable than the test group 5.

b) The chicken extract in the test groups 1 to 6, packed in each container, were kept in a 50° C. incubator for 1 week or 1 month and then samples were taken.

One ml of each sample was added to nutrient agar medium which had been kept at 50° C., mixed, plated in a petri dish and incubated at 50° C. for 48 hours to observe the growth of bacteria.

Results are shown in Table 2.

In Table 2, when a growth of colonies equivalent to the test group 3 is observed, it is indicated by “++”; when a growth of colonies is observed but is obviously less than that of the test group 3, it is indicated by “+”; if there is no colony, it is indicated by “−”.

TABLE 2

| | Concentration of | Storage Time | Storage Time |
|---|---|---|---|
| Test Group | Emulsifier (%) | 1 week | 1 month |
| 1 | 0.1 | − | − |
| | 0.05 | − | − |
| | 0.03 | − | − |
| | 0.01 | ++ | ++ |
| 2 | 0.1 | − | − |
| | 0.05 | − | − |
| | 0.03 | − | − |
| | 0.01 | − | − |
| | 0.005 | + | ++ |
| 3 | 0 | ++ | ++ |
| 4 | 0 | − | − |
| 5 | 0 | − | − |
| 6 | 0 | ++ | ++ |

As shown in table 2, the test groups 4 and 5 sterilized by the retort method and the UHT method, respectively, could be stored for a long time without adding emulsifier.

On the other hand, the result of the test group 6 indicated that long-term storage was not possible if the sample was heat treated at a lower temperature without adding emulsifier.

In contrast, the test groups 1 and 2, which had been heated by the UHT method with the same condition as the test group 6, could be stored for a long time by adding the emulsifier and had a good preservability similar to that of the retort sterilization and the UHT sterilization at high temperature.

c) The chicken extract of the test groups 1, 2 and 6 were diluted by 10-fold with water, 0.3% of salt was added and subjected to a three-point identification test. Every chicken extract had good flavor and there was no significant difference among the test groups.

According to results of a) to c), it is obvious that meat extract with good preservability without impairing the flavor can be produced by adding emulsifier to the meat extract and conducting to the UHT sterilization.

### EXAMPLE 2

The emulsifiers shown in Table 3 were added to the chicken extract prepared in the reference example 1 described below to final concentrations of 0.005 percent by weight, 0.01 percent by weight and 0.05 percent by weight. Furthermore, the spore suspension of Bacillus stearothermophilus prepared in the reference example 2 was added to each chicken extracts so that the final concentration was about 300 spores/ml.

Each chicken extract sample to which the emulsifier and spore suspension were added was conducted to the UHT sterilization at 125° C. for 10 seconds using a Small Volume Liquid Continuous Sterilization Test Machine RMS type (Hisaka Works Co. Ltd.), and then packed aseptically into a 300 ml aluminum pouch.

A control sample was prepared by treating the meat extract in the same manner as above but without adding the emulsifier.

After 1 week of packing the aluminum pouches, sample was taken aseptically from each chicken extract. The sample was added and mixed with the nutrient agar medium which had been kept at 50° C., plated and incubated at 50° C. for 48 hours to observe the growth of bacteria.

The following monoglycerin fatty acid esters were used: Sunsoft 700P-2 (Taiyo Kagaku Co., Ltd.) having 8 carbon atoms in the fatty acid; Sunsoft 760 (Taiyo Kagaku Co., Ltd.) having 10 carbon atoms in the fatty acid; Sunsoft 750 (Taiyo Kagaku Co., Ltd.) having 12 carbon atoms in the fatty acid; and Sunsoft #8002 (Taiyo Kagaku Co., Ltd.) having 14 carbon atoms in the fatty acid. The content of the monoglycerin fatty acid ester in each preparation was about 90 percent by weight.

The following diglycerin fatty acid esters were used: Sunsoft Q-8D (Taiyo Kagaku Co., Ltd.) having 8 carbon atoms in the fatty acid; Sunsoft Q-12D (Taiyo Kagaku Co., Ltd.) having 12 carbon atoms in the fatty acid; and Sunsoft Q-14D (Taiyo Kagaku Co., Ltd.) having 14 carbon atoms in the fatty acid. The content of the diglycerin fatty acid ester in each preparation was about 90 percent by weight.

Sorgen 100 (DAI-ICHI KOGYO SEIYAKU Co. Ltd) having 8 carbon atoms in the fatty acid was used as a sorbitan fatty acid ester.

Results are shown in Table 3.

In Table 3, when the growth of colonies is equivalent to the test group 3, it is indicated by “++”; when the growth of colonies is observed but less than that of the test group 3, it is indicated by “+”; when no colony is observed, it is indicated by “−”.

TABLE 3

| | No. of Carbon atoms | Concentration | |
|---|---|---|---|
| Emulsifier | in fatty acid | (percent by weight) | Colony |
| Control | — | 0 | ++ |
| Monoglycerin | C8 | 0.005 | ++ |
| fatty acid ester | C8 | 0.01 | − |
| | C8 | 0.05 | − |
| | C10 | 0.005 | ++ |
| | C10 | 0.01 | − |
| | C10 | 0.05 | − |
| | C12 | 0.005 | ++ |
| | C12 | 0.01 | − |
| | C12 | 0.05 | − |
| | C14 | 0.005 | ++ |
| | C14 | 0.01 | ++ |
| | C14 | 0.05 | − |
| Diglycerin | C8 | 0.005 | ++ |
| fatty acid ester | C8 | 0.01 | ++ |
| | C8 | 0.05 | − |
| | C12 | 0.005 | ++ |
| | C12 | 0.01 | − |
| | C12 | 0.05 | − |
| | C14 | 0.005 | + |
| | C14 | 0.01 | − |
| | C14 | 0.05 | − |
| Sorbitan | C8 | 0.005 | ++ |
| fatty acid ester | C8 | 0.01 | ++ |
| | C8 | 0.05 | − |

As shown in Table 3, it is obvious that the meat extract can be sterilized more efficiently by the UHT sterilization with any emulsifier including monoglycerin fatty acid esters, diglycerin fatty acid esters and sorbitan fatty acid esters than the control.

### REFERENCE EXAMPLE 1

One hundred fifty kg of a mixture of chicken bone and chicken meat and 350 kg of water were placed in a pressure cooker and extracted by heating at 115° C. for 1 hour. After the extraction, the cooker was cooled naturally to 70° C., and the liquid portion was recovered from an outlet disposed at the bottom of the cooker so that no floating oil was included in the liquid portion, resulting in 350 kg of the chicken bone liquid extract. The liquid extract was a clear liquid with a Brix 4 and 0.2 percent by weight of crude fat concentration. This liquid extract was concentrated by an Evapor type CEP1 (Okawara Manufacturing Co., Ltd.) to obtain about 140 kg of a clear liquid with Brix 10 and 0.5 percent by weight of crude fat concentration. This concentrated liquid was used as the chicken extract.

### REFERENCE EXAMPLE 2

Bacillus stearothermophilus was spread on a nutrient agar medium (Nissui Pharmaceutical Co., containing 35 g of meat extract, 10 g of peptone, 0.15 g of sodium chloride and 15 g of agar in 1 l water), incubated at 50° C. for 48 hours, and then spore formation was confirmed by a microscopic observation. Cells on the agar medium were collected by scraping, suspended in sterilized water and heated in a boiling water bath for 10 minutes. After centrifuging for 10 minutes, the resulting precipitate was suspended in sterilized water and heated again in the boiling water bath for 10 minutes. The heated cell suspension was centrifuged for 10 min and the precipitate was recovered. The precipitate was suspended in sterilized water to a spore concentration of 3×10⁴ to 3×10⁵/ml to be used as the spore suspension.

### INDUSTRIAL APPLICABILITY

The present invention provides a method for improving the preservation of meat extract, a process for producing a meat extract with improved preservation, and a meat extract with improved preservation.

1. A process for producing a meat extract, which comprises a step for adding an emulsifier and a step for sterilizing by a UHT method.

2. The process according to claim 1, wherein the emulsifier is selected from a group consisting of monoglycerin fatty acid ester, diglycerin fatty acid ester, sucrose fatty acid ester and sorbitan fatty acid ester.

3. The process according to claim 1, wherein the meat extract is a clear meat extract.

4. A method for improving preservation of meat extract, which comprises adding an emulsifier and sterilizing by a UHT method.

5. The method according to claim 4, wherein the emulsifier is selected from a group consisting of monoglycerin fatty acid ester, diglycerin fatty acid ester, sucrose fatty acid ester and sorbitan fatty acid ester.

6. The method according to claim 4, wherein the meat extract is a clear meat extract.

7. A meat extract obtainable by any of the process according to claim 1.
